(19) United States
(12) Patent Application Publication
(10) Pub. No.: US 2009/0061913 A1
(43) Pub. Date: Mar. 5, 2009

(54) Cellular telephone with mirror display

(76) Inventor: Michael Woodruff, Downers Grove, IL (US)

Correspondence Address: Clifford Kraft, 320 Robin Hill Dr., Naperville, IL, 60540, US

(21) Appl. No.: 11/895,866

(22) Filed: Aug. 28, 2007

(51) Int. Cl. H04M 1/02

(52) U.S. Cl. 455/466; 455/566

(57) ABSTRACT

A cellular telephone or any other handheld electronic device or computer or laptop equipped with a display and at least one key that can be a hard key, soft key, menu command, icon or voice activated command, where the key controls the display so that upon activation of that key, the display turns either partially or totally into a mirror while the device remains operational. A second key can optionally control the degree of fade between data display and mirror so that optionally data can appear superimposed either totally or partially on the mirror. The display can also contain a banner above or below the mirror (or anywhere) where caller ID, SMS messages or any other message can be displayed. Optionally, these messages can be overlaid on the display when a partial mirror (a mode where data and mirror functions merge together). The device can also optionally contain a set of lights that shine outward onto the user's face that can be controlled and/or dimmed by control of a key to increase visibility in the mirror in a darkened environment.

### BACKGROUND

1. Field of the Invention

The present invention relates generally to the field of cellular telephones and more particularly to a cellular telephone or other handheld electronic device with a display that can become an electronic mirror.

2. Description of the Prior Art

Cellular telephones and handheld electronic devices are well known in the art as are automobile visor mirrors and the like. Many mirrors appear in ladies' compacts and in other arrangements. It is very desirable, especially for ladies, to have a mirror handy to adjust makeup, etc. It would also be very desirable to have this form part of a cellular telephone or other handheld electronic device since most people nowadays carry cellular telephones. This would avoid the necessity of having to carry multiple items. A cellular telephone with a fixed mirror is taught by Moles in U.S. Pat. No. 6,424,823 as a generally fixed device mounted in the telephone as though the telephone were a compact. U.S. Pat. No. 6,424,823 is hereby incorporated by reference. Moles also teaches that the display screen can turn into a mirror when the telephone is turned off. A fixed mirror like that taught by Moles has the major disadvantage of using a lot of surface real estate on the telephone, real estate that is needed for buttons, screens, etc. A screen that turns into a mirror only when the telephone is powered off is not very useful since users would not want to hang up a call or power down the telephone to use the mirror.

It would be advantageous to have a cellular telephone with an electronic screen that could turn either partially or totally into a mirror under control of a key or button on the telephone or a soft key, menu choice or under voice activation.

### SUMMARY OF THE INVENTION

The present invention relates to a cellular telephone or any other handheld electronic device or to a computer or laptop computer equipped with a display at least one key that can be a hard key, soft key, menu command, icon or voice activated command, where the key controls the display so that upon activation of that key, the display turns into a mirror either totally or partially with the device remaining operational. A second key can optionally control the degree of fade between data display and mirror so that optionally data can appear superimposed either totally or partially on the mirror. The display can also optionally contain a banner above or below the mirror area (or anywhere) where caller ID and/or SMS messages can be displayed, or these messages can be overlaid on a partially mirror (a mode where data and mirror functions merge together). The device can optionally contain a light or set of lights that shine outward onto the user's face that can be controlled and/or dimmed by control of a key to increase visibility in the mirror in a darkened environment.

### DESCRIPTION OF THE FIGURES

Attention is now directed to a set of illustrations that display the concepts of the present invention:

FIG. 1 shows a perspective view of an embodiment of the mirror telephone of the present invention.

FIG. 2 shows a side view of the embodiment of FIG. 1.

FIG. 3 shows a side view of an embodiment of the invention with some internal parts shown in dashed lines and light from the optional lights shining outward toward a user.

FIG. 4 shows a block diagram of an embodiment of the present invention.

FIG. 5 shows a perspective view of an embodiment of the present.

FIG. 6 shows a menu item and soft key.

Several drawings have been presented to aid in the understanding of the present invention. The scope of the present invention is not limited to what is shown in the figures.

### DESCRIPTION OF THE INVENTION

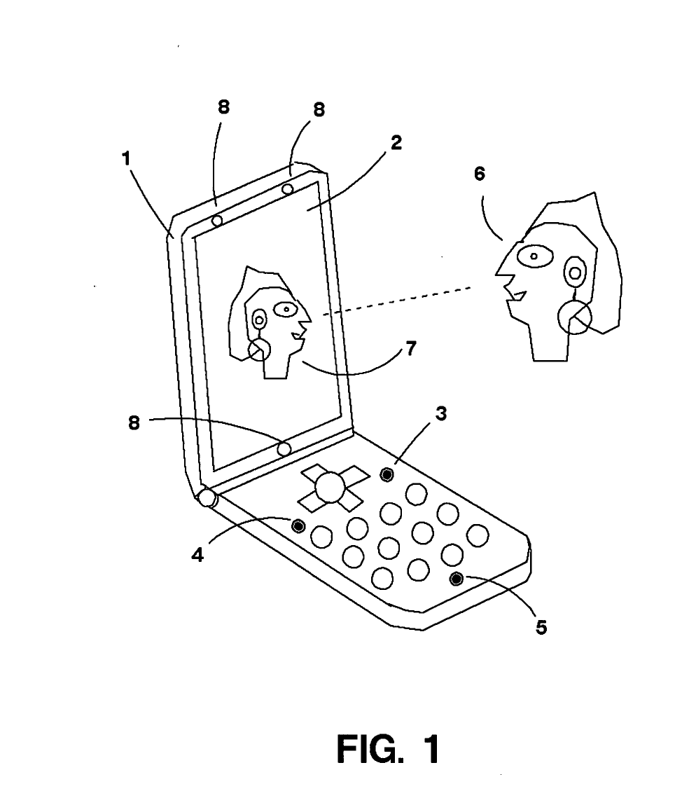

The present invention relates to a cellular telephone or other handheld electronic device that contains a display that can become a mirror either partially or totally under control of one or more keys while the device remains operational. The keys can be hard keys, soft keys, menu items, icons or voice commands. Turning to FIG. 1, a perspective view of an embodiment of the invention can be seen. A cellular telephone 1 or other electronic device containing a transceiver (not shown) and capable of making normal cellular telephone calls on a CDMA, GSM, 3G or 4G or other cellular network is shown. Alternatively, the device can be in the form of a computer or laptop (not shown). The device contains a display 2 that under control of a key 4 can become a mirror. In one embodiment, simply pressing the mirror control key 4 causes the display 2 to toggle between an electronic state where it is a normal display and a second electronic state where it is a mirror. FIG. 1 shows the device in the mirror state with a user 6 looking at the mirror screen and seeing a reflection 7. Optional lights 8 can shine outward to illuminate the face of the user. These lights 8 can be under control of another key or keys 5 that can turn them on and off and/or can dim them.

In an alternate embodiment, another key 3 could cause the display screen to fade from a full display state through a series of continuous or discreet mirror states and finally into a full mirror state. The fade process could be frozen by the user at any point. This embodiment allows the user to still see data behind (merged with) the mirror so that items like time, SMS messages and caller ID can still be seen superimposed on the mirror image.

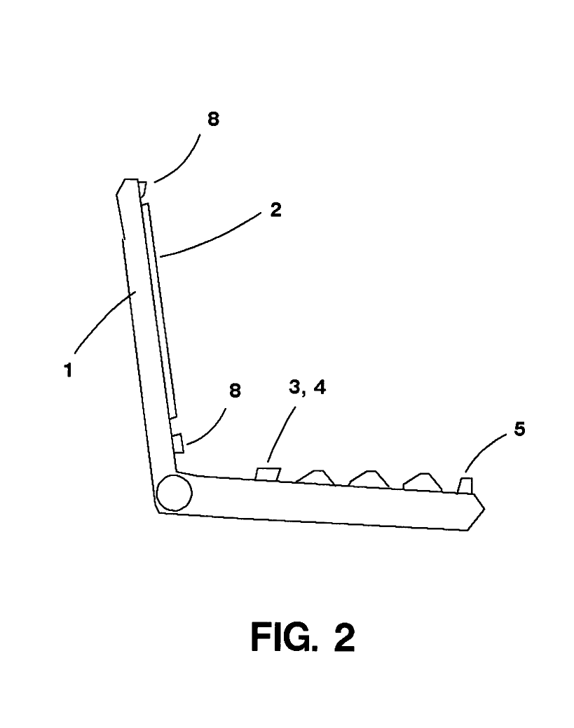

FIG. 2 shows a side view of the embodiment of FIG. 1. The special features of the present invention can be seen as display/mirror control keys 3, 4, lights 8, and one or more light control keys 5.

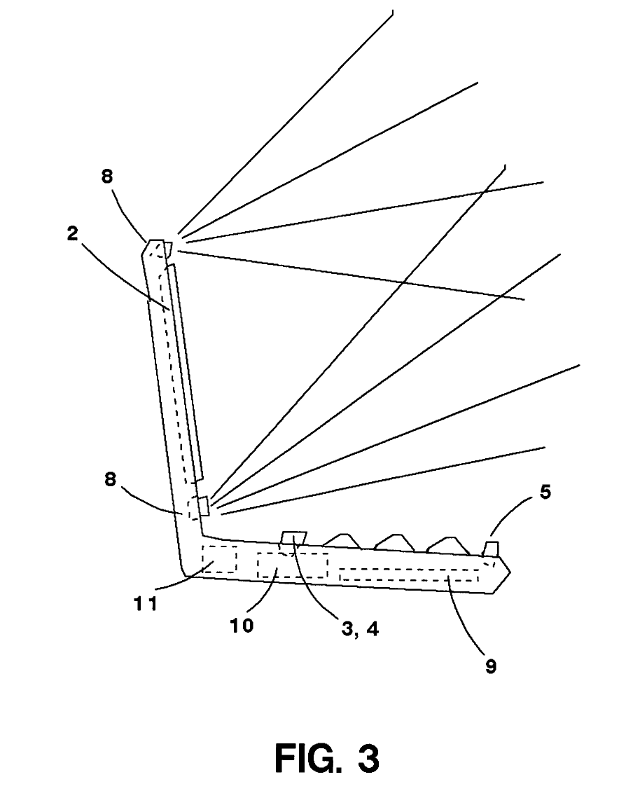

FIG. 3 shows a side view of an embodiment of the mirror telephone or electronic device with several internal components shown in dashed lines. A CPU or other processor 9 can control a display driver device 10 and an optional light driver 11. FIG. 3 also shows beams of light radiating outward toward the user from one or more lights 8 mounted above, below or around the display.

The present invention can use conventional LCD or any other display device for their screens. It is known in the art how to cause a display to become a mirror surface. This can be done with nano- or micro-active regions that exhibit a reflective property when activated, or other techniques can be used such as simple LCD devices that become reflective under electronic control or that are mounted under a special layer of material that becomes reflective upon activation by an electronic signal, current or voltage. While some ways to cause a display to turn into a total or partial mirror have been presented, any means or method of making a display have mirror characteristics is within the scope of the present invention.

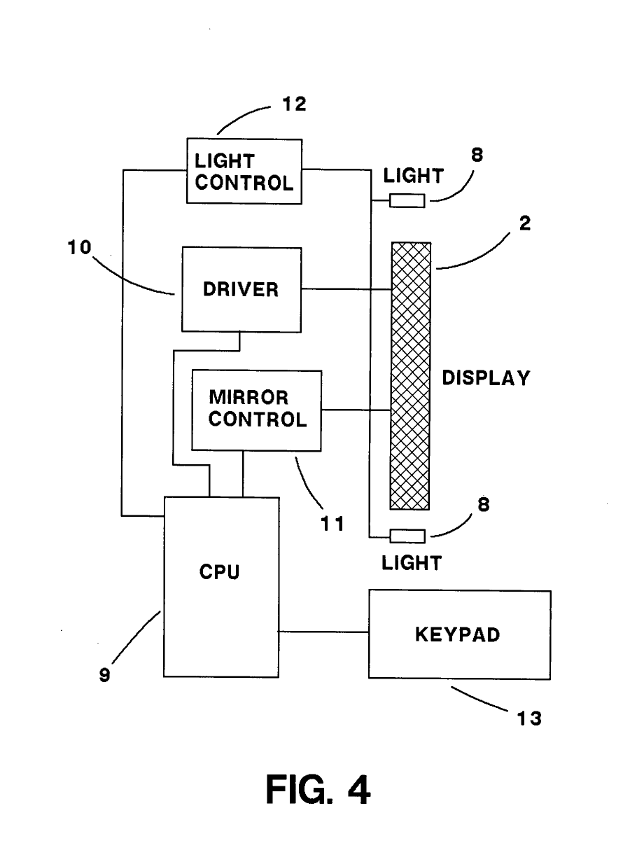

FIG. 4 shows a block diagram of a particular embodiment of the present invention. A CPU or other processor 9 controls a keypad 13 and other devices. The keypad 13 can contain all of the normal keys found on conventional cellular telephones or handheld electronic devices as well ad special keys for controlling the mirror aspects of the display as well as a key or keys for controlling and/or dimming the lights previously described. The CPU 9 can generally read the keypad 13 in ways known in the art and send data to a display driver 10. In addition, the CPU 9 can read the special display control keys such as a mirror control key 4 that can cause the display to turn into a mirror, an optional fade control key 3 that can cause the display to fade into a partial mirror to a degree determined by the user such as how long the user presses the fade key 3 and an optional light control key or dimmer key 5 to turn on or dim a light or set of lights 8 that can illuminate the user's face in a dark environment (like a darkened room). The light control 12 can receive commands from the CPU 9 to adjust the lights as described. In an optional embodiment, the lights could be disabled when the telephone is not in a mirror mode or a partial mirror mode (in a straight data mode). The mirror control 11 can receive commands from the CPU 9 to set the display 2 to the desired mirror state or mode.

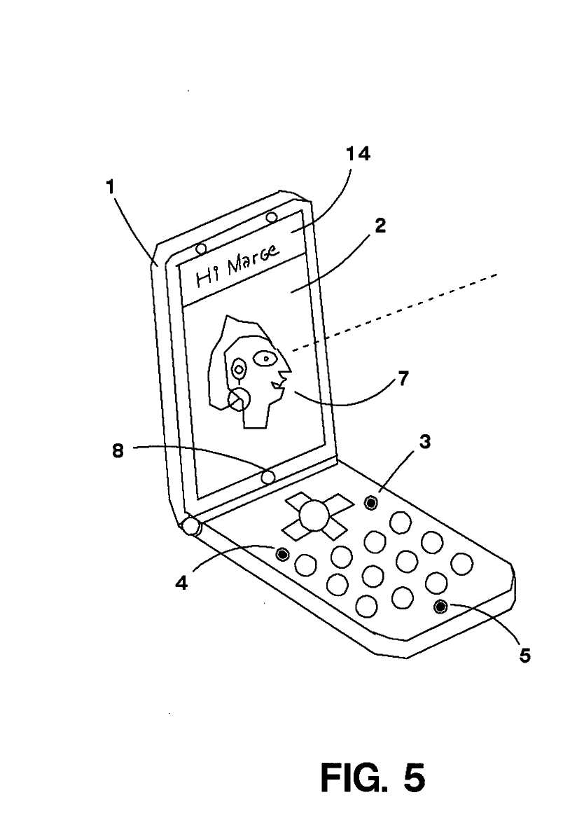

FIG. 5 shows a perspective view of an embodiment of the present invention. Here, a message can be seen across the top of the display screen 2. The message could be in a banner area 14, or it could be the result of merge on a partial mirror as previously discussed. This message could be an incoming or outgoing SMS or other message, a caller ID, a stock quote, an emergency warning, or any other message of any type, numeric or alphanumeric. The display 2 can be seen to be in a partial or total mirror mode because of the presence of a reflection 7. Again, lights 8 can optionally be used to illuminate the user.

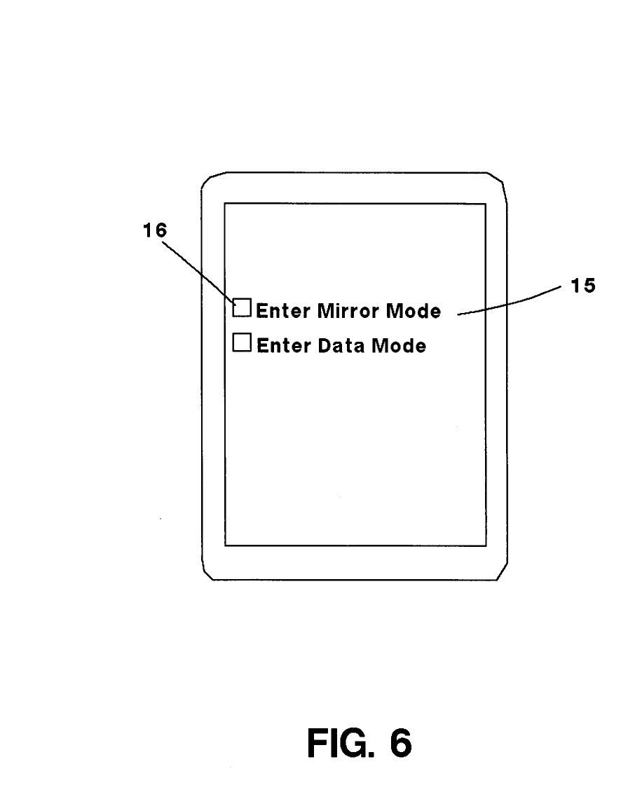

FIG. 6 shows an example of a soft key 16 and a menu item 15. These could be used in place of hard keys or a keypad to cause the device to enter or leave mirror mode, and/or to control the lights. An icon can also be used.

It should be noted that while several configurations for a mirror telephone or other handheld electronic device have been presented, many others are possible. In particular, the display 2 that becomes a partial or total mirror could be mounted on the back or top cover (outside) of the device, or anywhere else on the device as well as inside. Optional lights 8 could be provided as necessary. These can be inside or outside the device. The mirror display could be a separate display with alternative uses in a non-mirror mode. Also, other keys with other functions related to the mirror mode can be provided. In particular, mirror control and light control keys can be separate or integrated with a standard keyboard. As previously stated, these commands could come from codes entered on regular keys or from soft menus. In the case of a soft menu, the mirror control key and/or the light control key are logical keys rather than physical keys. These logical keys can be operated as soft keys or menu selections in the normal way. In the context of the present invention, the mirror control keys and the light control keys can equally be soft keys, hard keys or menu selections, icons or they can be any other way of commanding or entering data into a cellular telephone or handheld electronic device. In particular, the mirror control key or light control key might comprise a spoken command that is processed through voice recognition.

It should be noted that a very important feature of the present invention is the ability to switch the display from a data mode to a mirror mode or partial mirror mode without shutting off the phone or device, and without losing calls or the ability to make calls or to send and/or receive data. The mirror mode can be entered at any time, during a call, during an idle period, while receiving internet data, etc. A single hold-down key or button could optionally evoke a mirror mode only as long as the key is depressed. Thus a user, even during a call or use of the internet, could depress the mirror control key, enter mirror mode, adjust makeup for example, and quickly return to data display mode just by releasing the key.

While the present invention has been described for cellular telephones, it can be used with any electronic handheld device. This can include game controllers, TV or media controllers, PDAs, music or video devices, radios, car key FOBs and any other handheld device that could have a display.

In an alternative embodiment of the present invention, the device can be a desktop or laptop computer with a special display that can become a mirror under mouse or keyboard control exactly as in the case of the handheld devices. Again, the command can be an hard key, a menu item, an icon or could be voice activated or activated by any means or method for commanding or controlling a computer.

Several descriptions, illustrations and examples have been presented to better aid in understanding the present invention. A person skilled in the art will realize that there are numerous changes and variations that can be made without departing from the spirit of the invention. Each of these changes and variations is within the scope of the present invention.

I claim:

1. A electronic device comprising:
a display;
a first mirror control key;
wherein said display has a first display mode displaying data to a user and a second display mode reflecting light as a mirror; and,
wherein activation of said first mirror control key causes said display to switch between said display modes, said switching occurring while said cellular telephone is operational.

2. The electronic device of claim 1 further comprising a second mirror control key, wherein said second mirror control key causes said first display mode to partially fade into said second display mode to a degree determined by said user.

3. The electronic device of claim 1 further comprising a CPU, wherein said CPU controls said display and reads said first mirror control key.

4. The electronic device of claim 2 further comprising a CPU, wherein said CPU controls said display and reads said first and said second mirror control keys.

5. The electronic device of claim 1 further comprising a mirror mode display driver wherein said mirror mode display driver applies a voltage to said display in response to said first mirror control key to change said display from said first display mode to said second display mode.

6. The electronic device of claim 2 further comprising a first mirror display driver wherein said first mirror display driver applies a first voltage to said display in response to said first mirror control key to change said display from said first display mode to said second display mode, and wherein a second mirror display driver applies a second voltage to said display in response to said second mirror control key to cause said first display mode to partially fade into said second display mode.

7. The electronic device of claim 1 further comprising at least one light illuminating said user's face.

8. The electronic device of claim 7 further comprising a light control key controlling or dimming said light.

9. The electronic device of claim 1 wherein said electronic device is a cellular telephone.

10. The electronic device of claim 1 further comprising a display banner displaying a message in said second display mode.

11. The electronic device of claim 10 wherein said message is chosen from the group consisting of an SMS message and a caller ID.

12. The electronic device of claim 1 wherein said mirror control key is a soft key, icon, menu entry or voice command.

13. A electronic device including a display that can be changed from a data display to a mirror under control of at least one key while the electronic device is operational.

14. The electronic device of claim 13 further comprising at least one light for illuminating a user's face.

15. The electronic device of claim 13 further comprising a data banner on said display operational for displaying a message when said display is a mirror.

16. The electronic device of claim 15 wherein said message is chosen from the group consisting of an SMS message and a caller ID.

17. A handheld device comprising a display, said display changing from a data display mode to a light reflective mode upon activation of a control key.

18. The handheld device of claim 17 wherein said control key is a hard key, soft key, a menu selection, an icon or a voice command.

19. The handheld device of claim 17 further comprising at least one light for illuminating a user.

20. The handheld device of claim 17 adapted to display a message when in said light reflective mode.
